(19) United States
(12) Patent Application Publication
(10) Pub. No.: US 2021/0184813 A1
(43) Pub. Date: Jun. 17, 2021

(54) HASHING FOR ALLOCATION OF CONTROL CHANNEL CANDIDATES

(71) Applicant: NOKIA TECHNOLOGIES OY, Espoo (FI)

(72) Inventors: Volker BRAUN, Stuttgart (DE); Esa TIIROLA, Kempele (FI); Karol SCHOBER, Helsinki (FI); Klaus HUGL, Wien (AT)

(21) Appl. No.: 16/762,766

(22) PCT Filed: Nov. 16, 2018
(86) PCT No.: PCT/US2018/061583

§ 371 Date: May 8, 2020

Related U.S. Application Data
(60) Provisional application No. 62/588,039, filed on Nov. 17, 2017.

(51) Int. Cl. H04L 5/00; H04L 9/06; H04W 72/12

(52) U.S. Cl. CPC H04L 5/0053; H04W 72/1289; H04L 9/0643; H04L 5/0094

(57) ABSTRACT

Various communication systems may benefit from allocation of candidates for a channel. For example, some new radio communication systems may benefit from hashing for allocation of control channel candidates. A method can include applying a hashing function for associating a plurality of decoding candidates of a search space set with subsets of control channel elements of a control resource set, and using the decoding candidate for scheduling of a user equipment in a control channel, wherein the hashing function is non-uniform in a pseudo-random manner and with one candidate per subband. The method can also include scheduling the user equipment based on the applied hashing function.

### CROSS-REFERENCE TO RELATED APPLICATIONS

This application claims priority from U.S. provisional patent application No. 62/588,039 filed on Nov. 17, 2017. The contents of this earlier filed application are hereby incorporated in their entirety.

### BACKGROUND

### Field

Various communication systems may benefit from allocation of candidates for a channel. For example, some new radio communication systems may benefit from hashing for allocation of control channel candidates.

### Description of the Related Art

New radio (NR) physical downlink control channel (PDCCH) may be used to convey downlink control information (DCI). It may utilize orthogonal frequency division multiplexed (OFDM) waveform and polar coding. NR physical downlink control channel (PDCCH) may utilize every fourth resource element for demodulation reference signaling (DMRS). DCI can be used for downlink (DL) and uplink (UL) resource allocation signaling. It may be used also for other purposes, such as carrier aggregation and bandwidth part (BWP) (de)activation, frame structure indication (Group common PDCCH) and power control updates.

### SUMMARY

According to a first embodiment, a method can include applying a hashing function for associating a plurality of decoding candidates of a search space set with subsets of control channel elements of a control resource set, and using the decoding candidate for scheduling of a user equipment in a control channel, wherein the hashing function is non-uniform in a pseudo-random manner and with one candidate per subband. The method can also include scheduling the user equipment based on the applied hashing function.

In a variant, the hashing function can define a set of monitored control channel elements of a control resource set for each search space of a search space set.

In a variant, the control channel can be a physical downlink control channel.

In a variant, a control resource set can be divided into M_{full} subbands, and allocation of a candidate within a subband can be randomized.

In a variant, a carrier specific offset can be added to a pseudo-random number to provide randomization.

In a variant, the number of PDCCH candidates of certain aggregation level can be given by specification or configurable.

In a variant, the hashing function can include a max (1,) function configured to allow the number of configurable subbands for an aggregation level to be larger than the number of control channel elements within the control resource set divided by the aggregation level.

In a variant, the number of subbands M_{full} of a certain aggregation level can be configurable, fixed in the specification, equal to the number of PDCCH candidates or given by the maximum of the applicable number of candidates of a certain aggregation level.

In a variant, the number of subbands defined by the hashing function can be determined according to M_{full}.

In a variant, mapping of the PDCCH candidates may start from the first subband or alternatively can be randomized using a defined randomization procedure.

In a variant, the randomization within the subband may be performed by using different randomization generator initialization values for the different PDCCH candidates of a certain aggregation level.

In a variant, the control resource set is partitioned into subbands of variable size in terms of the number of allocated control channel elements, where the subband boundaries may be defined by means of the floor operator.

In a variant, the subband sizes in terms of the number of allocated control channel elements are given by

$$L \cdot ⌊ \frac{( {m}^{′} + 1 ) \cdot {N}_{C C E}}{L \cdot {M}_{full}^{( L )}} ⌋ - L ⌊ \frac{{m}^{′} \cdot {N}_{C C E}}{L \cdot {M}_{full}^{( L )}} ⌋ .$$

In a variant, a random generator may be used to define the random variable distance from one PDCCH candidate to the next PDCCH candidate of a certain aggregation level.

In a variant, a random generator may be used to define the association between the decoding candidates of a search space set and the control channel elements of the control resource set for a set of subframes.

According to a second embodiment, a method can include receiving a control channel to which a hashing function has been applied, wherein the hashing function is non-uniform in a pseudo-random manner and with one candidate per subband. The method can further include decoding the control channel based on the applied hashing function.

The second embodiment can be used together with the first embodiment including each of its variants.

According to third and fourth embodiments, an apparatus can include means for performing the method according to the first and second embodiments respectively, in any of their variants.

According to fifth and sixth embodiments, an apparatus can include at least one processor and at least one memory including computer program code. The at least one memory and the computer program code can be configured to, with the at least one processor, cause the apparatus at least to perform the method according to the first and second embodiments respectively, in any of their variants.

According to seventh and eighth embodiments, a computer program product may encode instructions for performing a process including the method according to the first and second embodiments respectively, in any of their variants.

According to ninth and tenth embodiments, a non-transitory computer readable medium may encode instructions that, when executed in hardware, perform a process including the method according to the first and second embodiments respectively, in any of their variants.

According to eleventh and twelfth embodiments, a system may include at least one apparatus according to the third or fifth embodiments in communication with at least one apparatus according to the fourth or sixth embodiments, respectively in any of their variants.

### BRIEF DESCRIPTION OF THE DRAWINGS

For proper understanding of the invention, reference should be made to the accompanying drawings, wherein:

FIG. 1 illustrates an example allocation of PDCCH candidates with a hashing function according to certain embodiments.

FIG. 2 illustrates PDCCH blocking probabilities, according to certain embodiments.

FIG. 3 illustrates a method according to certain embodiments.

FIG. 4 illustrates s system according to certain embodiments.

### DETAILED DESCRIPTION

The monitoring of the control channel in NR may be carried out by means of blind searches. Blind search or blind decoding (BD) may refer to the process by which a UE finds its PDCCH by monitoring a set of PDCCH candidates in every monitoring occasion. A monitoring occasion can be once a slot, once per multiple slots or multiple times in a slot. For example, physical downlink control channel (PDCCH) blind search may be arranged by means of parallel search spaces or search space sets mapped to one or multiple control resource sets (CORESETs). During a PDCCH blind search, a UE may be monitoring predefined control channel elements (CCEs), aggregated CCEs and/or downlink control information (DCI) sizes in predefined time instants, corresponding to configured monitoring occasions.

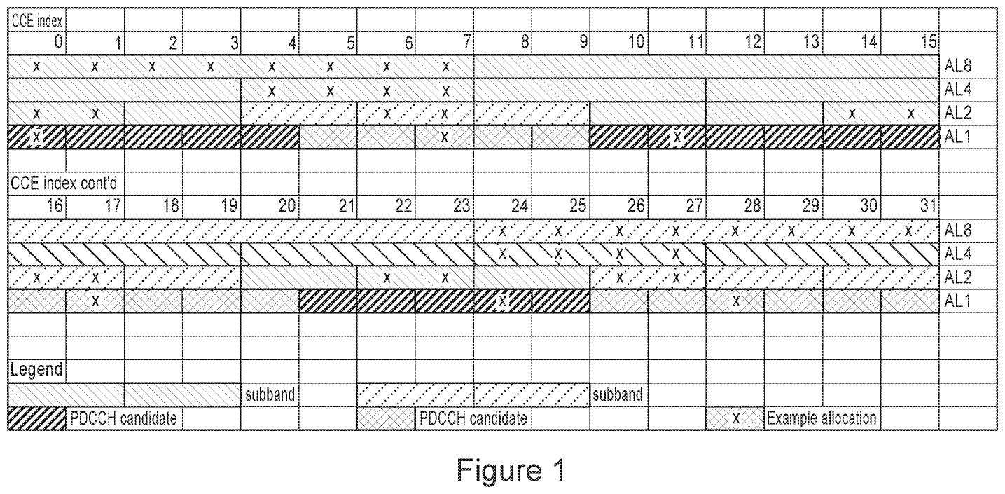

CCEs may be arranged within a predefined CORESET configured via higher layer signaling. Each CCE may include 6 resource element groups (REGs) (e.g., 12 subcarriers within 1 OFDM symbol), and 1, 2 or 3 REG bundles. REG bundles may be mapped into the CORESET either using interleaved or non-interleaved mapping. The UE may assume that REG bundle defines the precoder granularity in frequency and time used by gNB when transmitting PDCCH. CORESET resources may be configured in units of 6 resource blocks in the frequency. FIG. 1 (discussed below) illustrates an example PDCCH mapping assuming 1 symbol CORESET, interleaved REG-to-CCE mapping and REG bundle size 2. Table 1 below lists the REG bundle sizes options in terms of REGs, supported by new radio (NR).

TABLE 1

| | Non-interleaved | Interleaved |
|---|---|---|
| CORESET | mapping | mapping |
| length | (REG bundle: | (REG bundle: |
| (# symbols) | frequency × time) | frequency × time) |
| 1 | 5 (6 × 1) | 2 (2 × 1), 5 (6 × 1) |
| 2 | 5 (3 × 2) | 2 (1 × 2), 5 (3 × 2) |
| 3 | 5 (2 × 3) | 3 (1 × 3), 5 (2 × 3) |

Certain working assumptions and agreements have been made in 3GPP RANI working group meetings with respect to control channel blind search. For example, in the case when only CORESET(s) for slot-based scheduling is configured for a UE, the maximum number of PDCCH blind decodes per slot per carrier is X, where the value of X does not exceed 44. It remains for further consideration as to the exact value of X, as for multiple active BWP, for multiple TRP, for multiple carriers, for multi beams, for non-slot based scheduling, and as to numerology specific X.

Some further agreements or working assumptions have been made in 3GPP with respect to BD capabilities. Some of these agreements may include: PDCCH candidates having different DCI payload sizes count as separate blind decodes, PDCCH candidates comprised by different sets of CCE(s) count as separate blind decodes, PDCCH candidates in different CORESETs count as separate blind decodes, PDCCH candidates having the same DCI payload size and comprised by the same set of CCE(s) in the same CORESET count as one blind decodes.

The allocation of decoding candidates for the physical downlink control channel (PDCCH) can be accomplished using a hashing function that defines the association between the PDCCH candidates and the control channel elements (CCEs). As this association between PDCCH candidates and CCEs needs to be known in user equipment (UE) and next generation Node B (gNB), the same hashing functions needs to be implemented by gNB and UE. For example, the starting location of a user equipment (UE)-specific search space can be determined in every subframe using a hash or hashing function.

The hashing function of long term evolution (LTE) PDCCH has no sub-bands, and the blocking probability is not good. By contrast, the hashing function of LTE enhanced PDCCH (EPDCCH) has sub-bands, and the blocking probability is better than LTE PDCCH. Depending on the selected REG-to-CCE mapping, as shown in Table 1, a sub-band may cover adjacent or non-adjacent REGs of the CORESET. In both cases, with LTE PDCCH and LTE EPDCCH, the hashing function determines the association between the first decoding candidate and the respective CCEs in a pseudo-random manner in every subframe, and the association between the further decoding candidates of the search space and the respective CCEs is implicitly defined by the position of the CCEs of the first decoding candidate.

Objectives for a PDCCH hashing function may include low blocking probability and low computational complexity for determination of candidates in user equipment (UE) and next generation Node B (gNB). Another objective may be to enable frequency-selective scheduling on PDCCH, by having the possibility to allocate a candidate in a certain sub-band of the control resource set (CORESET). This option may be beneficial in the case of non-interleaved REG-to-CCE (or CCE-to-REG) mapping.

Certain embodiments provide a hashing function that is non-uniform in a pseudo-random manner and with one candidate per sub-band of the CORESET. Moreover, certain embodiments may be viewed as an extension of the LTE EPDCCH hashing function.

A particularity of LTE EPDCCH hashing function is that it can divide a CORESET into a number of M_{full} sub-bands and can allocate a single PDCCH candidate within each subband, where only the starting point of the first (m=0) PDCCH candidate is randomized, while the allocation of the further (m=1, 2, . . . , M−1) PDCCH candidates is deterministic and approximately equidistant. If the CORESET is configured with non-interleaved REG-to-CCE or CCE-to-Reg mapping, this property enables the allocation of a PDCCH candidate in a frequency-selective manner.

In certain embodiments, this principle can be extended, such that the CORESET can be divided into M_{full} subbands, but the allocation of the PDCCH candidate within a subband is randomized. For this purpose, the generation of further pseudo-random numbers may be required. As with the EPCCH hashing function, this procedure may enable the allocation of a PDCCH candidate in a frequency-selective manner, but compared to EPDCCH hashing function it often results in significantly lower blocking probability.

Advantages of certain embodiments of this method may include increased throughput, reduced latency and increased reliability of the data transmission. Such benefits may be due to reduced blocking probability, which may permit more users to be scheduled on average within a subframe with a given CORESET configuration. Additionally, low blocking probability on the PDCCH may be useful for the provisioning of highly reliable services.

The division of the CORESET into M_{full} subbands for aggregation level L can be expressed by the start points of the mth subbands, given by L└mN_{CCE}/LM_{full} ┘, where └ . . . ┘ denotes the floor { . . . } operator. Within the mth subband, the number of opportunities to pseudo-randomly allocate a PDCCH candidate can be given by {└(m+1)N_{CCE}/LM_{full}┘−└mN_{CCE}/LM_{full}┘}. In this equation N_{CCE} can represent a number of control channel elements within the CORESET. By introducing the pseudo-random variable Z_{k,m} to randomize the starting position within a subband, the following hashing function is obtained:

$$L ⌊ \frac{{m}^{′} \cdot {N}_{C C E}}{L \cdot {M}_{full}^{( L )}} ⌋ + L \{ ( {Z}_{k , m} + b ) mod ( max \{ 1 , ⌊ \frac{( {m}^{′} + 1 ) \cdot {N}_{C C E}}{L \cdot {M}_{full}^{( L )}} ⌋ - ⌊ \frac{{m}^{′} \cdot {N}_{C C E}}{L \cdot {M}_{full}^{( L )}} ⌋ \} ) \} + i$$

which is applicable for any combination on the number of CCEs within a CORESET N_{CCE}, aggregation level L, number of subbands M_{full}^{(L)} and number of PDCCH candidates M^{(L)} for aggregation level L. In case the number of CCEs in a CORESET is greater or equal than the number of sub-bands multiplied by the aggregation level L (i.e. N_{CCE}≥L·M_{full}^{(L)}), the hashing function above can be simplified as

$$L ⌊ \frac{{m}^{′} \cdot {N}_{C C E}}{L \cdot {M}_{full}^{( L )}} ⌋ + L \{ ( {Z}_{k , m} + b ) mod ( ⌊ \frac{( {m}^{′} + 1 ) \cdot {N}_{C C E}}{L \cdot {M}_{full}^{( L )}} ⌋ - ⌊ \frac{{m}^{′} \cdot {N}_{C C E}}{L \cdot {M}_{full}^{( L )}} ⌋ ) \} + i .$$

The number of subbands M_{full}^{(L)} can be configurable, fixed in specification, equal to the number of PDCCH candidates or given by the maximum of the applicable number of candidates M^{(L)}. The hashing function can contain also carrier specific offset b, defining the search-space of the carrier with index corresponding to offset b.

The mapping of the m-th PDCCH candidate to a respective subband may be given by just setting m′=m which leads to start mapping the candidates in increasing subband order from the first subband but may lead to an unequal usage of the subbands in case M^{(L)}≠M_{full}^{(L)}. To enable a more equal distribution of the candidates over the subbands, a mapping function in the spirit of m′=(Z_{k,0}+m) mod M_{full}^{(L)} with m=0, 1, . . . ,M^{(L)}−1 can be applied instead which randomizes the starting subband for the candidate mapping.

The randomization is performed as in case of LTE PDCCH or LTE EPDCCH using a random generator initialized by a given starting value Y₋₁ and using the legacy initialization for the first PDCCH candidate of the CORESET of an AL whereas a different initialization sequence is to be used for the remaining PDCCH candidates of aggregation level L of the CORESET. This can be given by the following two initialization settings

Z_{k,0}=Yₖ(AYₖ₋₁)mod D, for k=0,1, . . . 9,

and

Z_{k,m}=(A′Z_{k,m-1})modD, for m=1,2, . . . ,M^{(L)}−1.

using as an example the LTE settings for A, D and Y₋₁, given by A=39829, D=65537 and Y₋₁=RNTI. For the initialization of the other than the first candidate a different value A′ than A is required to guarantee the intended randomization between different users candidates. As an example value A′=39827 can be used.

FIG. 1 illustrates an example allocation of PDCCH candidates with a hashing function according to certain embodiments. More particularly, an example for the allocation of PDCCH candidates with a hashing function is illustrated in FIG. 1 for N_{CCE}=32, and M=M_{full}=(6, 6, 2, 2) for aggregation levels L=(1, 2, 4, 8).

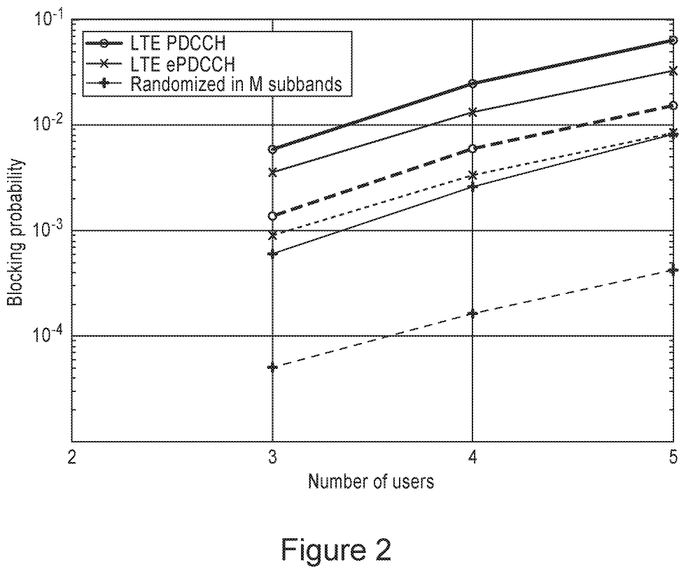

FIG. 2 illustrates PDCCH blocking probabilities, according to certain embodiments. More particularly, FIG. 2 illustrates PDCCH blocking probabilities with CORESET inclusing 32 CCEs (solid) and 64 CCEs (dashed).

In FIG. 2, it can be seen that the hashing function of LTE EPDCCH outperforms that of LTE PDCCH by a factor of ˜2-3 in blocking probability. It can also be seen that the hashing function outperforms the hashing function of LTE EPDCCH by about one order of magnitude in blocking probability.

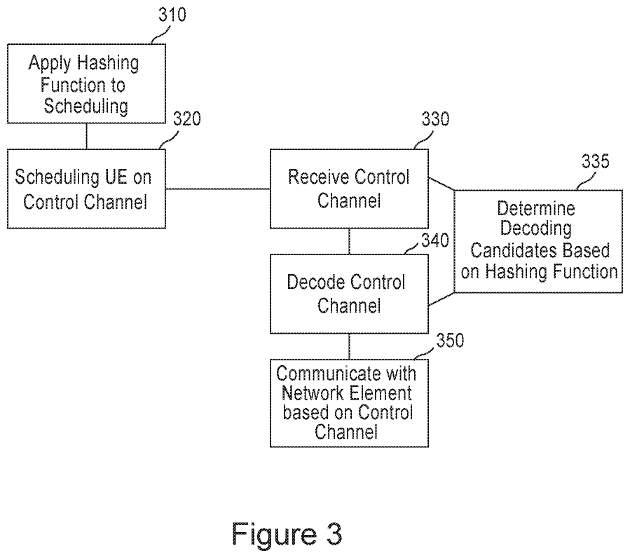

FIG. 3 illustrates a method according to certain embodiments. As shown in FIG. 3, a method can include, at 310, applying a hashing function for associating a plurality of decoding candidates of a search space set with subsets of control channel elements of a control resource set, and using the decoding candidate for the scheduling of a user equipment in a control channel. The hashing function can be non-uniform in a pseudo-random manner and with one candidate per subband, if there is sufficient amount of CCEs in a CORESET to cover the configured candidates. For example, the hashing function may be as described above with reference to FIGS. 1 and 2.

The control channel can be a physical downlink control channel A control resource set can be divided into M_{full} subbands, and allocation of a candidate within a subband can be randomized. The method can also include, at 320, scheduling the user equipment based on the applied hashing function. The hashing function may deliver a set of decoding candidates together with the respective CCEs within the configured CORESET, and a particular decoding candidate may be selected for transmission of a control information on the control channel, for example, DCI containing information for the receiver how to receive or transmit a data packet.

The method can further include, at 330, receiving a control channel to which a hashing function has been applied. This can be the same hashing function mentioned at 310 above. The hashing function may deliver a set of decoding candidates, as shown at 335. The method can additionally include, at 340, decoding the control channel based on the applied hashing function, for example, by blind decoding of all the candidates delivered by the hashing function.

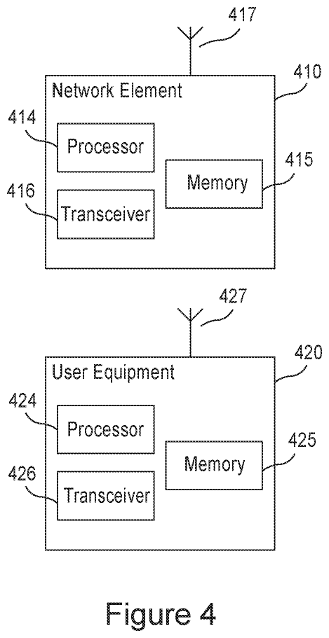

FIG. 4 illustrates a system according to certain embodiments of the invention. It should be understood that each block of the flowchart of FIG. 3 may be implemented by various means or their combinations, such as hardware, software, firmware, one or more processors and/or circuitry. In one embodiment, a system may include several devices, such as, for example, network element 410 and user equipment (UE) or user device 420. The system may include more than one UE 420 and more than one network element 410, although only one of each is shown for the purposes of illustration.

A network element can be an access point, a base station, an eNode B (eNB), or any other network element, such as a gNB. Each of these devices may include at least one processor or control unit or module, respectively indicated as 414 and 424. At least one memory may be provided in each device, and indicated as 415 and 425, respectively. The memory may include computer program instructions or computer code contained therein, for example for carrying out the embodiments described above. One or more transceiver 416 and 426 may be provided, and each device may also include an antenna, respectively illustrated as 417 and 427. Although only one antenna each is shown, many antennas and multiple antenna elements may be provided to each of the devices. Other configurations of these devices, for example, may be provided. For example, network element 410 and UE 420 may be additionally configured for wired communication, in addition to wireless communication, and in such a case antennas 417 and 427 may illustrate any form of communication hardware, without being limited to merely an antenna.

Transceivers 416 and 426 may each, independently, be a transmitter, a receiver, or both a transmitter and a receiver, or a unit or device that may be configured both for transmission and reception. The transmitter and/or receiver (as far as radio parts are concerned) may also be implemented as a remote radio head which is not located in the device itself, but in a mast, for example. It should also be appreciated that according to the “liquid” or flexible radio concept, the operations and functionalities may be performed in different entities, such as nodes, hosts or servers, in a flexible manner. In other words, division of labor may vary case by case. One possible use is to make a network element to deliver local content. One or more functionalities may also be implemented as a virtual application that is provided as software that can run on a server.

A user device or user equipment 420 may be a mobile station (MS) such as a mobile phone or smart phone or multimedia device, a computer, such as a tablet, provided with wireless communication capabilities, personal data or digital assistant (PDA) provided with wireless communication capabilities, vehicle, portable media player, digital camera, pocket video camera, navigation unit provided with wireless communication capabilities or any combinations thereof. The user device or user equipment 420 may be a sensor or smart meter, or other device that may usually be configured for a single location.

In an exemplifying embodiment, an apparatus, such as a node or user device, may include means for carrying out embodiments described above in relation to FIGS. 1 through 3.

Processors 414 and 424 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors. Additionally, the processors may be implemented as a pool of processors in a local configuration, in a cloud configuration, or in a combination thereof. The term circuitry may refer to one or more electric or electronic circuits. The term processor may refer to circuitry, such as logic circuitry, that responds to and processes instructions that drive a computer.

For firmware or software, the implementation may include modules or units of at least one chip set (e.g., procedures, functions, and so on). Memories 415 and 425 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity is typically internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as network element 410 and/or UE 420, to perform any of the processes described above (see, for example, FIG. 3). Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C #, Java, etc., or a low-level programming language, such as a machine language, or assembler. Alternatively, certain embodiments of the invention may be performed entirely in hardware.

Furthermore, although FIG. 4 illustrates a system including a network element 410 and a UE 420, embodiments of the invention may be applicable to other configurations, and configurations involving additional elements, as illustrated and discussed herein. For example, multiple user equipment devices and multiple network elements may be present, or other nodes providing similar functionality, such as nodes that combine the functionality of a user equipment and an access point, such as a relay node.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

### LIST OF ABBREVIATIONS

CORESET Control resource set

CCE Control channel element

DCI Downlink control information

DL Downlink

gNB NR base station

LTE Long term evolution

NR New Radio

PDCCH Physical Downlink Control Channel

UE User equipment

1. A method, comprising:
applying a hashing function for associating a plurality of decoding candidates of a search space set with subsets of control channel elements of a control resource set;
using at least one of the decoding candidates for scheduling of a user equipment in a control channel, wherein the hashing function is non-uniform in a pseudo-random manner and with one candidate per sub-band; and
scheduling the user equipment based on the applied hashing function.

2. The method according to claim 1, wherein the hashing function defines a set of monitored control channel elements of the control resource set for each search space of the search space set.

3. The method according to claim 1, wherein the control channel is a physical downlink control channel.

4. The method according to claim 1, wherein the control resource set is divided into M_{full} sub-bands, and allocation of a candidate within the sub-band is randomized.

5. The method according to claim 1, wherein a carrier specific offset is added to a pseudo-random number to provide randomization.

6. The method according to claim 3, wherein the number of physical downlink control channel candidates of certain aggregation level is given by specification or configurable.

7. The method according to claim 1, wherein the hashing function includes a max function configured to allow the number of configurable sub-bands for an aggregation level to be larger than the number of control channel elements within the control resource set divided by the aggregation level.

8. The method according to claim 4, wherein the number of sub-bands M_{full} of a certain aggregation level is configurable, fixed in the specification, equal to the number of physical downlink control channel candidates or given by the maximum of the applicable numbers of candidates of a certain aggregation level.

9. The method according to claim 4, wherein the number of sub-bands defined by the hashing function is determined according to M_{full}.

10.-15. (canceled)

16. An apparatus, comprising:
at least one processor; and
at least one memory comprising computer program code,
the at least one memory and computer program code configured, with the at least one processor, to cause the apparatus at least to
apply a hashing function for associating a plurality of decoding candidates of a search space set with subsets of control channel elements of a control resource set;
use at least one of the decoding candidates for scheduling of a user equipment in a control channel, wherein the hashing function is non-uniform in a pseudo-random manner and with one candidate per sub-band; and
schedule the user equipment based on the applied hashing function.

17. The apparatus according to claim 16, wherein the hashing function defines a set of monitored control channel elements of the control resource set for each search space of the search space set.

18. The apparatus according to claim 16, wherein the control channel is a physical downlink control channel.

19. The apparatus according to claim 16, wherein the control resource set is divided into M_{full} sub-bands, and allocation of a candidate within the sub-band is randomized.

20. The apparatus according to claim 16, wherein a carrier specific offset is added to a pseudo-random number to provide randomization.

21. The apparatus according to claim 18, wherein the number of physical downlink control channel candidates of certain aggregation level is given by specification or configurable.

22. The apparatus according to claim 16, wherein the hashing function includes a max function configured to allow the number of configurable sub-bands for an aggregation level to be larger than the number of control channel elements within the control resource set divided by the aggregation level.

23. The apparatus according to claim 19, wherein the number of sub-bands M_{full} of a certain aggregation level is configurable, fixed in the specification, equal to the number of physical downlink control channel candidates or given by the maximum of the applicable numbers of candidates of a certain aggregation level.

24.-31. (canceled)

32. A method, comprising:
receiving a control channel to which a hashing function has been applied, wherein the hashing function is non-uniform in a pseudo-random manner and with one candidate per sub-band; and
decoding the control channel based on the applied hashing function.

33. An apparatus, comprising:
at least one processor; and
at least one memory comprising computer program code,
the at least one memory and computer program code configured, with the at least one processor, to cause the apparatus at least to
receive a control channel to which a hashing function has been applied, wherein the hashing function is non-uniform in a pseudo-random manner and with one candidate per sub-band; and
decode the control channel based on the applied hashing function.

34. (canceled)

35. A computer program embodied on a non-transitory computer-readable medium comprising program instructions stored thereon which, when executed in hardware, cause the hardware to perform the method according to claim 1.
